(19) United States
(12) Patent Application Publication
(10) Pub. No.: US 2004/0189783 A1
(43) Pub. Date: Sep. 30, 2004

(54) Color printer and recording material feeding method

(75) Inventor: Shusuke Mogi, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/808,383

(22) Filed: Mar. 25, 2004

(30) Foreign Application Priority Data
Mar. 27, 2003 (JP) 2003-087843

(51) Int. Cl. B41J 2/315

(52) U.S. Cl. 347/218

(57) ABSTRACT

A color thermal recording material is fed by a feed roller pair having a capstan roller and a pinch roller along a feeding path at a speed as a basis of thermal recording. Along the feeding path, a yellow, a magenta and a cyan thermal heads are disposed to sequentially print a yellow, a magenta and a cyan images within a recording area of the color thermal recording material. The interval between the thermal heads is a multiple of an integer of circumferential length (πd) of the capstan roller. The feeding speed of the recording paper changes periodically due to the fine unevenness of the circumference of the capstan roller and eccentric shaft. Since the phase in the feeding speed of the color thermal recording material becomes coincident at each thermal head against the periodical fluctuation, deviation of color registration is prevented.

### BACKGROUND OF THE INVENTION

1. Field of the Invention

The present invention relates to a color printer and recording material feeding method, in particular, relates to a color printer and recording material feeding method which is suitable to prevent fluctuation of color registration.

2. Explanations of the Prior Arts

There are a color thermal printer, a color ink jet printer and a color laser printer as a color printer. Examples of the color thermal printer are a one-head three-pass type and a three-head one-pass type. In the one-head three-pass printer, a single thermal head is moved relative to color thermal recording paper back and forth three times to record a color image of yellow, magenta and cyan sequentially on a recording material like the color thermal recording paper. This color thermal recording paper is constructed with a cyan, a magenta and a yellow thermal coloring layers on a substrate in the order listed. On the other hand, in the three-head one-pass printer, three thermal heads are disposed at suitable intervals to pass the color thermal recording paper for one time. While the color thermal recording paper is moving and passing the three thermal heads successively, a yellow, a magenta and a cyan images are successively printed within a virtually sectioned recording area in a longitudinal direction of the color thermal recording paper, so that a full-color printing with an appropriate color degree is obtained. After the printing operation, the color thermal recording paper is cut along a cutting line of the recording area to be a color print sheet.

In the three-head one-pass printer, when the printing position of each color image does not become coincident, color registering failure occurs on the printed color image, to cause deterioration of image quality. Color registering failure occurs due to low device accuracy to convey the color thermal recording paper, improper ambient temperature (where a color thermal printer is set) and improper temperature in a printer (temperature of a feeder, a thermal head and so forth).

According to the conventional color thermal printer, deviation of color registration is corrected for each color. In case deviation occurs due to temperature, for instance, a deviation amount of the printing position is calculated for each color in order to be adjusted in accordance with the deviation amount. Moreover, there is a problem that device accuracy upon conveyance of the color thermal recording paper is different for each printer. In this regard, deviation of the printing position is adjusted during the inspection process of the printer manufacture.

Further, a thermal transfer printer, which sets print starting position for each color, and adjusts/changes the setting of the ink sheet tension in order to adjust deviation of color registration, is known (JPA No.9-234917, for instance).

However, the above technique that corrects deviation of color registration is not based on a periodical fluctuation of the feeding speed of the color thermal recording paper caused by subtle unevenness of the circumference of the circumference of a capstan roller and eccentricity of a pivotal shaft. As shown in FIG. 2A, the capstan roller 8 to convey the color thermal recording paper 2 has microscopically considerable unevenness, although its circumference is round. In case the capstan roller 8 rotates at a predetermined speed, if the capstan roller 8 has round circumference, the feeding speed of the color thermal recording paper 2 remains unchanged as a theoretical value shown by a dotted line of FIG. 2B. In fact, however, the capstan roller 8 has subtle unevenness on its circumference and its pivotal shaft is eccentric, to cause periodical fluctuation of the feeding speed as shown by a solid line of FIG. 2B. For this reason, the feeding amount slightly changes to generate color registration failure.

In order to take this problem, as described in JPA No.9-234917, a user conducts visual inspection to judge the deviation amount of color registration so as to be able to set the correction amount corresponding to the deviation amount of the color registration. It is difficult, however, to determine the highly exact correction amount as well as being troublesome, as visual inspection is conducted by human eyes. As another measures to prevent this, it is considered to increase accuracy of the size and assembly of the capstan roller. However, accuracy can not be raised over a mechanically limited level as well as the manufacture cost is likely to increase remarkably.

### SUMMARY OF THE INVENTION

An object of the present invention is to provide a color printer and a recording material feeding method that prevents occurrence of deviation of color registration caused by fine unevenness of the circumference of a capstan roller and an eccentric shaft.

Another object of the present invention is to provide a color printer and a recording material feeding method which prevents color registering deviation easily.

To attain the above objects of the present invention, the distance to feed the recording paper between print heads is determined as multiple of an integer multiplied by a circumference of the capstan roller. The feed roller pair consists of the capstan roller and the pinch roller so that the recording paper is fed along the feeding path. The plural print heads are arranged on the feeding path. Each color image is printed within the recording area while the recording material is being fed. As a print head, there are a yellow print head to print a yellow image, a magenta print head to print a magenta image and a cyan print head to print a cyan image.

According to the preferred embodiment of the present invention, the feed roller pair is disposed on an upstream side of each thermal head to feed the recording material toward each thermal head. Besides that, each front tension roller pair is disposed on a downstream side of each print head to apply front tension to the recording material during the printing operation. In addition, a back tension roller pair is disposed on the upstream side of the feed roller pair to apply back tension to the recording material. The front tension roller pair and the back tension roller pair are controlled to drive so that the total front tension of the plural front tension roller pairs can be equal to the back tension of the back tension roller pair. This enables the tension on the feed roller pair to be maintained within the stable region. Since the conveyance amount of the recording material is prevented from being fluctuated, further deviation of color registration can be prevented.

In accordance with the invention, the deviation in the color registration can be prevented because the interval between the print heads are a multiple of an integer multiplied by the circumferential length of the capstan roller. Since the phase in the feeding speed becomes coincident at each print head against the periodical fluctuation, deviation of color registration is prevented in spite of fine unevenness about the capstan roller or eccentricity of the shaft.

### BRIEF DESCRIPTION OF THE DRAWINGS

The above and other objects and advantages of the present invention will become apparent from the following detailed description of the preferred embodiments when read in association with the accompanying drawings, which are given by way of illustration only and thus are not limiting the present invention. In the drawings, like reference numerals designate like or corresponding parts throughout the several views, and wherein:

FIG. 1 is a perspective view illustrating structure of a color thermal printer of the present invention;

FIG. 2A is a side view in which a color thermal recording paper is conveyed by a capstan roller;

FIG. 2B is a graph illustrating fluctuation of the feeding speed while the capstan roller is making a single rotation; and

FIG. 3 is an explanatory view illustrating the feeding speed of the color thermal recording material whose feeding path is indicated in a rectilinear state.

### DETAILED DESCRIPTION OF THE EMBODIMENTS

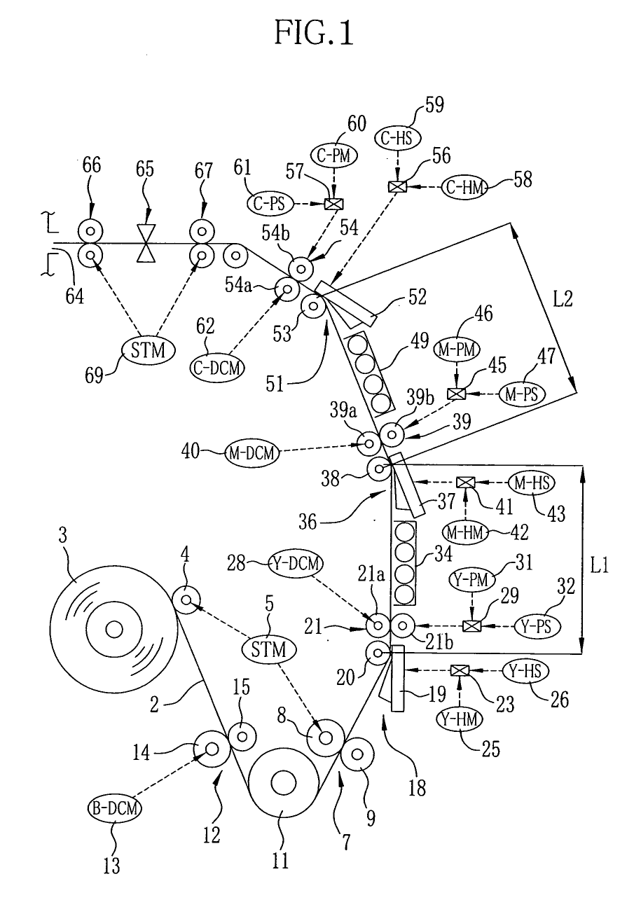

In FIG. 1, roll paper 3 is loaded in a supply section of a printer. A continuous color thermal recording paper 2 (referred to as a recording paper hereafter) is rolled to be the roll paper 3 as a recording material. A supply roller 4 contacts the periphery of the roll paper 3. Driven by a stepping motor (STM) 5, the supply roller 4 rotates the roll paper 3 to advance the recording paper 2, which is conveyed from the supply section through an outlet 64 for ejection. After the printing operation, the recording paper 2 is rewound into the roll paper 3. Its recording face is covered to prevent influence of light and moisture. It is also possible to set the roll paper 3 to the printer as loaded into a paper supply magazine.

As it is generally known, the recording paper 2 has a cyan, a magenta and a yellow thermal coloring layers that are laid on a substrate in the order listed. The yellow thermal coloring layer, the uppermost layer, has the highest thermosensitivity and develops yellow when small thermal energy is applied. Meanwhile, the cyan thermal coloring layer, the lowermost layer, has the lowest thermosensitivity and develops cyan when large thermal energy is applied. The yellow thermal coloring layer loses its coloring ability when visible violet rays with a wavelength whose peak value is 420 nm is applied thereto. The magenta thermal coloring layer develops magenta when thermal energy between the levels for the yellow thermal coloring layer and the cyan thermal coloring layer is applied, and loses its coloring ability when near ultraviolet rays with a wavelength whose peak value is 365 nm is applied. Otherwise, it is also possible to provide a black thermal coloring layer on the recording paper 2 to make it with four-layer structure.

A feed roller pair 7 to nip and convey the recording paper 2 is disposed within a feeding path. The feed roller pair 7 consists of a capstan roller 8 and a pinch roller 9. The capstan roller 8 is rotated by the stepping motor 5. The pinch roller 9 nips the recording paper 2 with the capstan roller 8 and is movable between a position to press the capstan roller 8 and a position away from the capstan roller 8 by a shift mechanism (not shown) that is composed of a cam, a solenoid and so forth. Note that various rollers other than the feed roller pair 7 will be described in detail. In the printer described herein, a rotational speed of the feed roller pair 7 is used as a predetermined basis for the purpose of sequential printing.

A correction roller 11 that corrects deviation of the recording paper 2 in a width direction for alignment is disposed on the upstream side of the feed roller pair 7 in a feeding direction of the recording paper 2. On the upstream of the correction roller 11, a back tension roller pair 12 that applies back tension to the recording paper 2 during the conveyance in a feeding direction.

The back tension roller pair 12 consists of a capstan roller 14 and a pinch roller 15. The capstan roller 14 is rotated by a DC motor (B-DCM) 13. The pinch roller 15 presses the capstan roller 14 to nip the recording paper 2, and is movable between a position to press the capstan roller 14 and a position away from the capstan roller 14.

A yellow print station 18 is arranged on the downstream side of the feed roller pair 7. The yellow print station 18 has a yellow thermal head 19, a platen roller 20 and a yellow front tension roller pair 21. The yellow thermal head 19, as well known, has a heating element array arranged in a line across the feeding of the recording paper 2. This heating element array presses and heats the recording paper 2 to print a yellow image on the yellow thermal coloring layer by one line. The platen roller 20 supports the recording paper 2 pressed by the yellow thermal head 19. The yellow front tension roller pair 21 nips and conveys the recording paper 2.

The yellow thermal head 19 is movable between the printing position to press the heating element array onto the recording paper 2 and the retract position away from the recording paper 2. The yellow thermal head 19 is moved by a yellow head moving mechanism 23. The yellow head moving mechanism 23 has a cam that presses the yellow thermal head 19 to move, and a yellow head motor (Y-HM) 25 that rotates the cam. The yellow head motor 25 uses a DC motor, for instance. The position of the yellow thermal head 19 is detected by a yellow head sensor (Y-HS) 26, for which a reflective photosensor is used, for instance.

The yellow front tension roller pair 21 consists of a capstan roller 21a and a pinch roller 21b. The capstan roller 21a is rotated by a yellow DC motor (Y-DCM) 28. The pinch roller 21b presses the capstan roller 21a to nip the recording paper 2. The pinch roller 21a is made movable by a yellow shift mechanism 29 between the two positions adjacent to the capstan roller 21a and the position away from the capstan roller 21a.

The yellow shift mechanism 29 has a cam (not shown) which presses the pinch roller 21b to move, and a yellow pinch motor (Y-PM) 31 which rotates the cam. The yellow pinch motor 31 uses a DC motor, for instance. The position of the pinch roller 21b is detected by a yellow pinch sensor (Y-PS) 32, for which a reflective photoelectric sensor is used, for instance.

The yellow front tension roller pair 21 conveys the recording paper 2 in the feeding direction. The feeding speed of the recording paper 2 by the yellow front tension roller pair 21 is set faster than that of the feed roller pair 7. However, the feeding amount of the yellow front tension roller pair 21 is determined by the control of the feed roller pair 7. As a result, the feeding speed of the recording paper 2 is kept as the feeding speed of the feed roller pair 7 at the yellow print station.

Furthermore, the back tension roller pair 12 generates the back tension equal to the front tension by the yellow front tension roller pair 21. Due to this, the tension to the feed roller pair 7 decreases, keeping the feeding speed of the recording paper 2 to the feeding speed of the feed roller pair 7 all the times.

A yellow fixing lamp 34 is disposed on the downstream side of the yellow print station 18. The yellow fixing lamp 34 emits electromagnetic radiation (visible violet ray) whose radiation peak is 420 nm for fixation in order to prevent color from developing even if the yellow thermal coloring layer of the recording paper 2 is heated.

A magenta print station 36 is disposed on the downstream side of the yellow fixing lamp 34. The magenta print station 36 has a magenta thermal head 37, a platen roller 38 and a magenta front tension roller pair 39. The magenta thermal head 37 has a heating element array which prints a magenta image on the magenta thermal coloring layer by one line. The platen roller 38 receives the recording paper 2 pressed by the magenta thermal head 37. A magenta DC motor (M-DCM) 40 drives a capstan roller 39a of the magenta front tension roller pair 39.

The magenta thermal head 37 is movable between the recording position and the retract position by a magenta head moving mechanism 41, which is driven by a magenta head motor (M-HM) 42. The position of the magenta thermal head 37 is detected by a magenta head sensor (M-HS) 43.

A pinch roller 39b of the magenta front tension roller pair 39 is movable by a magenta shift mechanism 45 between the position adjacent to the capstan roller 39a and the position away from the capstan roller 39a. The magenta shift mechanism 45 is driven by a magenta pinch motor (M-PM) 46. The position of the pinch roller 39b is detected by a magenta pinch sensor (M-PS) 47.

A magenta fixing lamp 49 is disposed on the downstream side of the magenta print station 36. The magenta fixing lamp 49 emits electromagnetic radiation (ultraviolet ray) whose radiation peak is 365 nm to fix the magenta thermal coloring layer.

A cyan print station 51 is disposed on the downstream side of the magenta fixing lamp 49. The cyan print station 51 has a cyan thermal head 52, a platen roller 53 and a cyan front tension roller pair 54. The cyan thermal head 52 has a heating element array to print a cyan image on the cyan thermal coloring layer by one line. The platen roller 53 supports the recording paper 2. The cyan front tension roller pair 54 has a capstan roller 54a rotated by a cyan DC motor (C-DCM) 62.

The cyan thermal head 52 and a pinch roller 54b are moved by a cyan head moving mechanism 56 and a cyan shift mechanism 57 respectively. The cyan head moving mechanism 56 is driven by a cyan head motor (C-HM) 58. The position of the cyan thermal head 52 is detected by a cyan head sensor (C-HS) 59. The cyan shift mechanism 57 is driven by a cyan pinch motor (C-PM) 60. The position of the pinch roller 54b is detected by a cyan pinch sensor (C-PS) 61.

The outlet 64 to eject the image-printed recording paper 2 is disposed on the end of the feeding path. A cutter 65 to cut the continuous recording paper 2 at a predetermined position to make it a sheet paper is disposed at the back of the outlet 64. In the vicinity of the cutter 65, there disposes an outlet roller pair 66 that ejects the recording paper 2 through the outlet 64 and a cutter roller pair 67 that conveys the recording paper 2 toward the cutter 65, both of which are driven by a stepping motor 69.

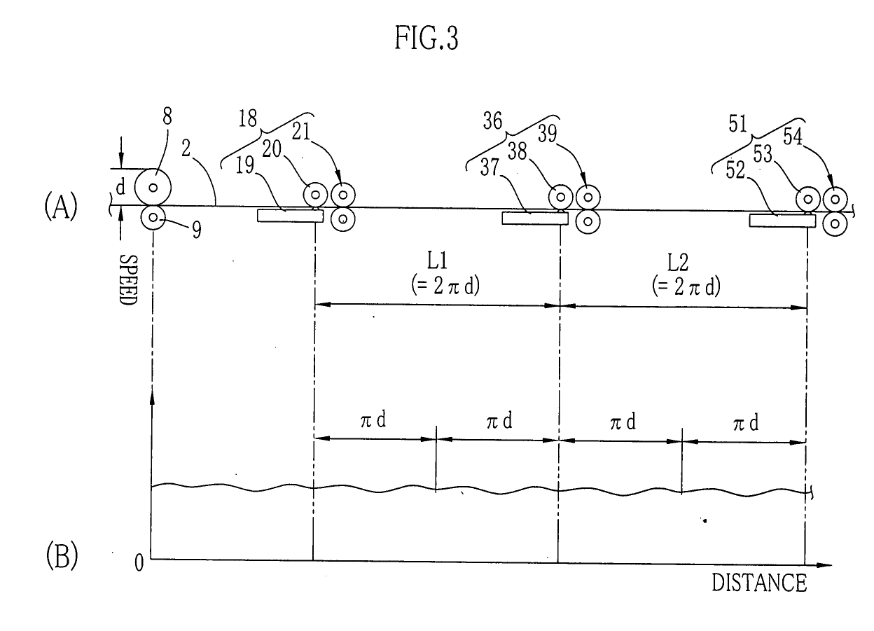

FIG. 3 is a virtual straight track of the feeding path shown in FIG. 1. The interval between the yellow thermal head 19 and the magenta thermal head 37 is determined as L1. And the interval between the magenta thermal head 37 and the cyan thermal head 52 is determined as L2. The intervals of each thermal head L1 and L2 are a multiple of an integer multiplied by the circumferential length πd of the capstan roller, which is determined as 2πd in the present embodiment.

The operation of the above embodiment is mentioned. When printing operation starts, the stepping motor 5 rotates the supply roller 4 in a feeding rotational direction. The recording paper 2 is pulled from the roll paper 3 and fed toward the back tension roller pair 12. Additionally, when the DC motor 13 is activated to rotate the capstan roller 14 in the feeding rotational direction, the recording paper 2 is fed toward the feed roller pair 7.

The recording paper 2 is contacted on the correction roller 11 in order to correct deviation in the width direction of the recording paper 2. When a front end of the recording paper 2, passing through the feed roller pair 7, is detected by a sensor (not shown) disposed on the downstream side of the feed roller pair 7, the shift mechanism of the feed roller pair 7 is activated to press the pinch roller 9 to the capstan roller 8. The capstan roller 8 in the feed roller pair 7 rotates in the feeding rotational direction to convey the recording paper 2 to the yellow print station 18.

When a front end of a first recording area, which is virtually sectioned on the recording paper 2, reaches the printing position, the yellow head moving mechanism 23 moves the yellow thermal head 19 to the recording position so as to press it onto the recording paper 2. Then, the yellow thermal head 19 generates heat to develop yellow of the yellow thermal coloring layer of the recording paper 2. A yellow image is printed within the first recording area by one line while feeding the recording paper 2.

The yellow front tension roller pair 21 applies the front tension to the feed roller pair 7 in printing the yellow image. This tension is larger than the frictional force arising from the yellow thermal head 19 and the recording paper 2. And the tension generates the feeding amount larger than that of the feed roller pair 7. The back tension roller pair 12, however, applies the back tension equal to the yellow front tension roller pair 21. Consequently, the tension on the feed roller pair 7 practically amounts to zero, so that the recording paper 2 is fed at the feeding speed of the capstan roller 8 controlled with the stepping motor 5.

In synchronism with printing the yellow image, the yellow fixing lamp 34 is turned on. The yellow fixing lamp 34 emits electromagnetic radiation (visible violet ray) whose radiation peak is 420 nm to fix the yellow image within the first recording area.

The recording paper 2 is fed in a successive manner during the fixing operation of the yellow image. The front end of the first recording area with yellow image is conveyed to the magenta print station 36. As the interval L1 between the yellow thermal head 19 and the magenta thermal head 37 is 2πd in the present embodiment, the capstan roller 8 makes just two rotations since the front end of the first recording area reached the yellow print station 18 to the magenta print station 36.

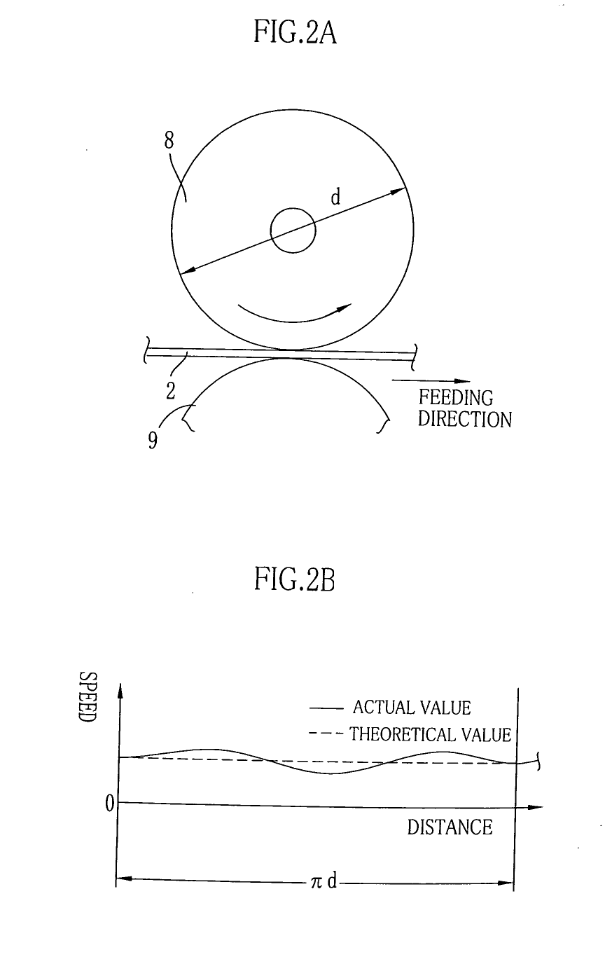

Owing to this, a phase deviation does not occur even if feeding speed changes periodically due to subtle unevenness of the circumference of the capstan roller 8 and eccentric shaft. This is because actual values of the feeding speed shown in FIG. 2B draw a waveform with two cycle patterns. The feeding speed when the front end of the first recording area reaches the magenta print station 36 is equal to the feeding speed upon arrival at the yellow print station 18.

When the first recording area reaches the magenta print station 36, the magenta head moving mechanism 41 moves the magenta thermal head 37 to the recording position to press onto the recording paper 2. Then, the magenta thermal head 37 generates heat to print the magenta image within the first recording area by one line. At the start of printing the magenta image, a second recording area of the recording paper 2 reaches the yellow print station 18. The yellow thermal head 19 prints the yellow image within the second recording area by one line while the recording paper 2 is being fed.

The yellow front tension roller pair 21 and the magenta front tension roller pair 39 apply the front tension to the feed roller pair 7 in printing the yellow and the magenta images. The back tension roller pair 12 generates the back tension equal to the sum of the front tension obtained by addition of tension of the yellow front tension roller pair 21 and the magenta front tension roller pair 39. As a result, the feeding speed of the recording paper 2 is kept to the feeding speed of the capstan roller 8 controlled with the stepping motor 5.

In synchronism with printing the yellow and the magenta images, the yellow fixing lamp 34 and the magenta fixing lamp 49 are turned on. Ultraviolet rays are emitted from the magenta fixing lamp 49 to fix the magenta image on the first recording area with the yellow and the magenta images. Then, ultraviolet rays are emitted from the yellow fixing lamp 34 to fix the yellow image on the second recording area with the yellow image.

The capstan roller 8 feeds the recording paper 2 to the cyan print station 51. Since the interval L2 between the magenta thermal head 7 and the cyan thermal head 52 is 2πd, the capstan roller 8 makes exact two rotations before the reach of the first recording area from the magenta print station 36 to the cyan print station 51. The phase is coincident in comparison with the feeding speed when the front end of the first recording area reaches the cyan print station 51 with when it reaches the magenta print station 36, so that the feeding speed becomes equal.

When the front end of the first recording area reaches the cyan print station 51, the cyan thermal head 52 prints the cyan image within the first recording area. In synchronism with printing of the cyan image, the magenta image is printed within a second recording area, and then the yellow image is printed within a third recording area.

Similarly, while printing the yellow, the magenta and the cyan images, the back tension roller pair 12 generates the back tension equal to the total front tension of three front tension roller pairs to stabilize the feeding speed of the recording paper 2. When the printing operation is conducted in each print station, color registration failure is prevented due to the phase of each feeding speed being coincident each other.

The cutter roller pair 67, driven by the stepping motor 69, feeds the first recording area with the yellow, the magenta and the cyan images into the cutter 65. The rear end of the recording paper 2 is cut by the cutter 65, ejected to be a color print of sheet form through the outlet 64 by the eject roller pair 66.

By repeating the above procedure, plural color prints are made successively. It is possible to make a single color print by printing within the only first recording area. In case printing operation is stopped, the part from behind the last printing area is neither colored nor fixed. In this case, when the yellow image is fixed, for instance, plural yellow fixing lamps are turned on successively in accordance with the position of conveyance of the recording area, then turned off successively. It is also possible to provide a well-known shutter which moves at speed equal to the feeding speed of the recording paper 2 so as to prevent the fixing lamp from applying ultraviolet rays to the recording paper 2. After ultraviolet rays from the fixing lamp are shielded by the shutter, the fixing lamp is turned off. After the final recording area is cut, each motor is rotated reversely to roll the recording paper 2 into the roll paper 3.

According to the above embodiment, the intervals L1 and L2 between the thermal heads are determined as twice of the circumferential length of the capstan roller. It is possible, however, to determine the intervals L1 and L2 as a multiple of an integer multiplied by the circumferential length of the capstan roller, for instance, three or four times of the circumferential length of the capstan roller. Moreover, it is possible to change the intervals L1 and L2, in place of their distance determined as equal. Furthermore, the feed roller pair 7 may be arranged on the downstream side of the front tension roller pair 54 so as to pull the recording paper 2.

The feed roller pair 7, the front tension roller pairs 21, 39, 54, and the back tension roller pair 12 are made of metal such as iron and so forth. It is possible to use hard rubber in order to make each roller pair instead of the metal.

Note that the feed roller pair 7 used as an element basically operating for sequential printing can be constructed for feeding with specifically high friction and high force of pressing. It is preferable for the remaining rollers to exert friction and force of pressing in an appropriately preset range of applying front or back tension.

A color printer with three thermal heads of yellow, magenta and cyan is taken for instance in the above embodiment. However, the number of the thermal head may be increased or decreased appropriately as long as its number is more than one. The present embodiment refers to the case when the color printer with continuous color thermal recording paper is used. However, the present invention is applicable for a color printer for a cut sheet as well.

Also, the present invention is applicable for a color thermal printer of a dye sublimation type which uses an ink sheet and other image forming apparatuses, as well as a color thermal printer of a thermal recording type. Furthermore, the present invention is also applicable for a color ink jet printer with an ink jet head as a print head and a color laser printer with a laser scanning unit for electrophotographic image forming.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A recording material feeding method for a color printer, said color printer having a feed roller pair for nipping and feeding recording material, and plural print heads disposed along a feeding path for printing different colors respectively, said feed roller pair being constituted of a capstan roller and a pinch roller, said recording material feeding method comprising the step of:
determining an interval between said print heads as equal to a distance of a multiple of an integer multiplied by a circumferential length of said capstan roller.

2. A recording material feeding method as claimed in claim 1, further comprising the steps of:
applying front tension to said recording material respectively on the downstream side of each print head in a feeding direction of said recording material; and
arranging said feed roller pair on the upstream side of said print heads in the feeding direction of said recording material.

3. A recording material feeding method as claimed in claim 2, further comprising the step of applying back tension on said recording material on the upstream side of said feed roller pair in the feeding direction of said recording material.

4. A recording material feeding method as claimed in claim 3, wherein said recording material is a color thermal recording material which is colorable in yellow, magenta and cyan in accordance with heating energy; and
said plural print heads are a yellow thermal head for developing yellow, a magenta thermal head for developing magenta and a cyan thermal head for developing cyan.

5. A color printer comprising:
a feed roller pair, arranged inside a feeding path of a continuous recording material, for nipping and feeding said recording material, said feed roller pair having a capstan roller and a pinch roller;
plural thermal heads, arranged on a downstream side of said feed roller pair, for heating said recording material in order to record one of the plural colors while feeding, and an interval between said thermal heads being a distance of a multiple of an integer multiplied by a circumferential length of said capstan roller;
plural front tension roller pairs, arranged on a downstream side of respectively said thermal heads, for applying front tension to said recording material; and
a back tension roller pair, arranged on an upstream side of said feed roller pair, for feeding said recording material while applying back tension to said recording material.

6. A color printer as claimed in claim 5, wherein the total of values of said front tension is equal to said back tension.

7. A color printer as claimed in claim 6, wherein said feed roller pair is driven by a stepping motor, and said back tension roller pair and each front tension roller pair are driven by at least one DC motor.

8. A color printer as claimed in claim 7, wherein said recording material is a color thermal recording material which is colorable in yellow, magenta and cyan in accordance with heating energy; and
said plural thermal heads are a yellow, a magenta and a cyan thermal heads that develop yellow, magenta and cyan respectively.
